(19) United States
(12) Patent Application Publication
(10) Pub. No.: US 2010/0044574 A1
(43) Pub. Date: Feb. 25, 2010

(54) PORTABLE RADIATION DETECTOR

(75) Inventors: Naoyuki NISHINO, Kanagawa (JP); Yutaka YOSHIDA, Kanagawa (JP); Yasunori OHTA, Kanagawa (JP); Keiji TSUBOTA, Kanagawa (JP); Takeshi KAMIYA, Kanagawa (JP)

Correspondence Address: Solaris Intellectual Property Group, PLLC, 401 Holland Lane, Suite 407, Alexandria, VA, 22314, US

(73) Assignee: FUJIFILM CORPORATION, Minato-ku, Tokyo (JP)

(21) Appl. No.: 12/538,889

(22) Filed: Aug. 11, 2009

(30) Foreign Application Priority Data
Aug. 20, 2008 (JP) 2008-211786

(51) Int. Cl. G01T 1/24

(52) U.S. Cl. 250/370.09

(57) ABSTRACT

A portable radiation detector includes: a housing accommodating therein a radiation detecting section that detects radiation; a structural member disposed at an outer side of the housing and formed integrally with the housing; and an antenna, provided at the structural member, for carrying out wireless communication of image data of a radiation image.

### CROSS-REFERENCE TO RELATED APPLICATION

This application is based on and claims priority under 35 USC 119 from Japanese Patent Application No. 2008-211786 filed on Aug. 20, 2008, the disclosure of which is incorporated by reference herein.

### BACKGROUND OF THE INVENTION

1. Field of the Invention

The present invention relates to a portable radiation detector that can be carried.

2. Description of the Related Art

The radiation image photographing device disclosed in Japanese Patent Application Laid-Open (JP-A) No. 2003-210444 is known as a portable radiation detector.

JP-A No. 2003-210444 points out the problem that electromagnetic waves of wireless communication affect the electronic circuits of the radiation image photographing device as noise, and bring about deterioration in image quality.

In the radiation image photographing device of JP-A No. 2003-210444, by placing an antenna having directivity at the reverse surface of the device, the wraparound of electromagnetic waves to the equipment can be reduced.

However, in the structure of JP-A No. 2003-210444, the antenna is incorporated in the radiation image photographing device and is disposed in a vicinity of the electronic circuits, therefore, sufficient effects cannot be expected merely by controlling the directivity. Further, an antenna having directivity is large, and is an impediment to making the radiation image photographing device itself compact. Increasing the antenna distance with a cable also has been proposed, but an antenna including a cable is even larger.

### SUMMARY OF THE INVENTION

In view of the above-described circumstances, the present invention mitigates the effects of electronic waves of an antenna on electronic parts, without increasing the size of a device.

A portable radiation detector according to an aspect of the present invention includes: a housing accommodating therein a radiation detecting section that detects radiation; a structural member disposed at an outer side of the housing and formed integrally with the housing; and an antenna, provided at the structural member, for carrying out wireless communication of image data of a radiation image.

### BRIEF DESCRIPTION OF THE DRAWINGS

An exemplary embodiment of the present invention will be described in detail based on the following figures, wherein:

FIG. 1 is a schematic drawing showing the placement of an electronic cassette at the time of photographing a radiation image;

FIG. 2 is a schematic perspective view showing the internal structure of the electronic cassette;

FIG. 3 is a block diagram schematically showing the schematic structure of the electronic cassette;

FIG. 4A is a drawing showing a state before a handle is pulled-out from a housing, and FIG. 4B is a drawing showing a state after the handle is pulled-out from the housing;

FIG. 5 is a schematic perspective view showing the structure of a self-standing leg provided at the housing;

FIG. 6 is a schematic perspective view showing a state of photographing a subject from the side with the electronic cassette that is made to stand on its own;

FIG. 7 is schematic perspective view showing the structure of a self-standing leg that can make the housing stand on its own horizontally or vertically;

FIG. 8 is a schematic perspective view showing the structure of a self-standing leg relating to a modified example;

FIG. 9 is a schematic perspective view showing a case in which the self-standing leg relating to the modified example is used as a grasping portion; and

FIG. 10 is a schematic perspective view showing a structure in which a radio wave absorber is provided at the housing.

### DETAILED DESCRIPTION OF THE INVENTION

(Structure of Electronic Cassette Relating to Present Exemplary Embodiment)

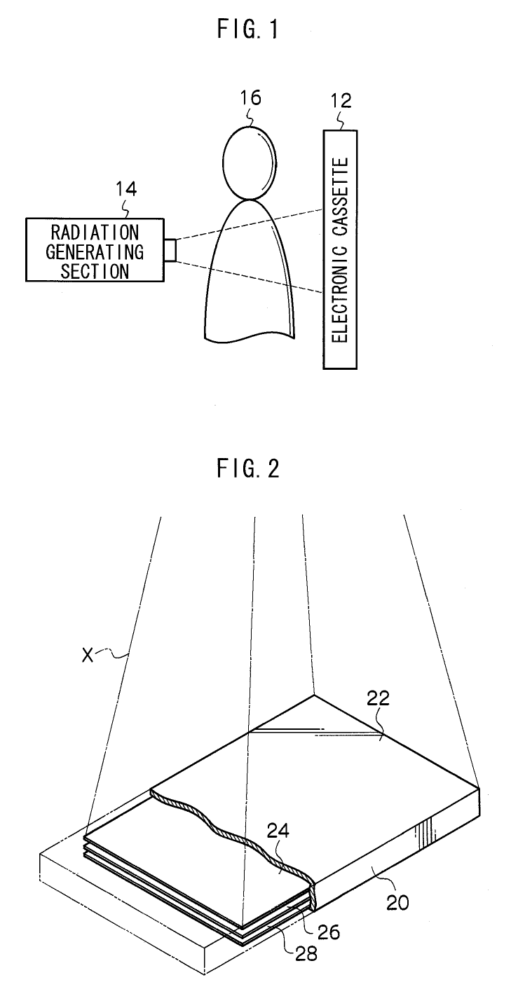

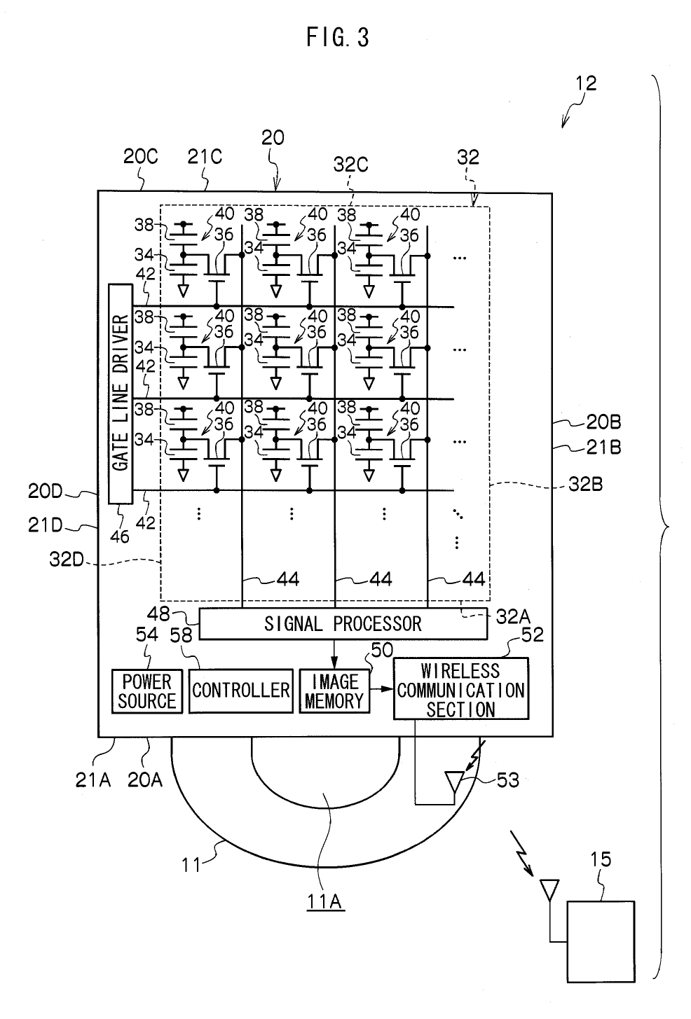

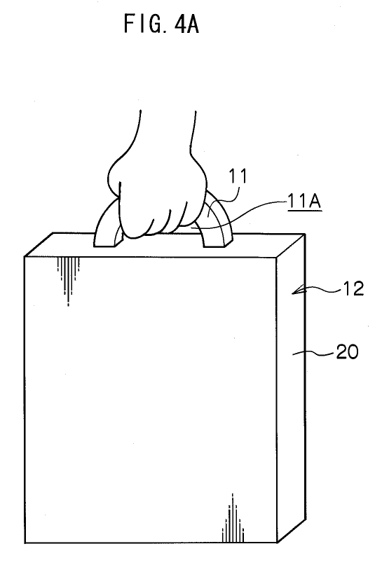

First, the structure of an electronic cassette, that is an example of a portable radiation detector, will be described. FIG. 1 is a schematic drawing showing the placement of the electronic cassette at the time of photographing a radiation image. FIG. 2 is a schematic perspective view showing the internal structure of the electronic cassette. FIG. 3 is a block diagram schematically showing the schematic structure of the electronic cassette.

An electronic cassette 12 relating to the present exemplary embodiment is a radiation photographing device that is portable, and detects radiation from a radiation source that has been transmitted through a photographic subject, and generates image information of a radiation image that is expressed by the detected radiation, and can store the generated image information. The electronic cassette 12 is concretely structured as follows. Note that the electronic cassette 12 may be a structure that does not store generated image information.

As shown in FIG. 1, at the time of photographing a radiation image, the electronic cassette 12 is disposed such that there is a space between the electronic cassette 12 and a radiation generating section 14 that serves as a radiation source that generates radiation. The region between the radiation generating section 14 and the electronic cassette 12 at this time is a photographing region at which a subject 16, the photographic subject, is positioned. When photographing of a radiation image is instructed, the radiation generating section 14 emits radiation with an amount of radiation set by photographing conditions and the like that are provided in advance. The radiation that is emitted from the radiation generating section 14 carries image information by being transmitted through the subject 16 who is positioned at the photographing position, and thereafter, is irradiated onto the electronic cassette 12.

As shown in FIG. 2, the electronic cassette 12 has a flat-plate-shaped housing 20 that is formed of a material through which radiation X can be transmitted, and that has a predetermined thickness. A grid 24, a radiation detecting panel 26 and a lead plate 28 are accommodated within the housing 20 in that order from an irradiation surface 22 side of the housing 20 at which the radiation X is irradiated. The grid 24 removes scattered radiation of the radiation X that arises as the radiation is transmitted through the subject 16. The radiation detecting panel 26 is an example of a radiation detector that detects radiation from the radiation generating section 14 that has passed through the subject 16. The lead plate 28 absorbs the back-scattered radiation of the radiation X.

The radiation detecting panel 26 of the electronic cassette 12 is structured such that a photoelectric converting layer, that absorbs radiation and converts it into charges, is layered on a TFT active matrix substrate 32 shown in FIG. 3. The photoelectric converting layer is formed from, for example, an amorphous a-Se (amorphous selenium) whose main component is selenium (e.g., a content of greater than or equal to 50%). When radiation is irradiated, the photoelectric converting layer generates, at the interior thereof, charges (electron-hole pairs) of a charge amount corresponding to the irradiated radiation amount, and thereby converts the irradiated radiation into charges.

Note that, instead of an X-ray—charge converting material such as amorphous selenium that directly converts the radiation X into charges, the radiation detecting panel 26 may convert the radiation X into charges indirectly by using a fluorescent material and photoelectric converting elements (photodiodes). Gadolinium oxysulfide (GOS) and cesium iodide (CsI) are well known as fluorescent materials. In this case, conversion from X-rays into light is carried out by the fluorescent material, and the conversion from light into charges is carried out by the photodiodes that are photoelectric converting elements.

Further, numerous pixel portions 40 are arranged in the form of a matrix on the TFT active matrix substrate 32. (In FIG. 3, the photoelectric converting layer corresponding to the individual pixel portions 40 is shown schematically as photoelectric converting portions 38.) The pixel portion 40 has a storage capacitor 34 that accumulates charges generated at the photoelectric converting layer, and a TFT 36 for reading-out the charges accumulated in the storage capacitor 34. The charges, that are generated at the photoelectric converting layer accompanying the irradiation of radiation onto the electronic cassette 12, are accumulated in the storage capacitors 34 of the individual pixel portions 40. Due thereto, a radiation image, that is expressed by the radiation that has been transmitted through the photographic subject and irradiated onto the electronic cassette 12, is converted into image information in accordance with charges, and is held at the radiation detecting panel 26.

Gate lines 42 and data lines 44 are provided at the TFT active matrix substrate 32. The gate lines 42 are plural lines that extend in a given direction (the row direction) and are for turning the TFTs 36 of the individual pixel portions 40 on and off. The data lines 44 are plural lines that extend in a direction (the column direction) orthogonal to the gate lines 42 and are for reading-out the accumulated charges from the storage capacitors 34 via the TFTs 36 that have been turned on. The individual gate lines 42 are connected to a gate line driver 46, and the individual data lines 44 are connected to a signal processor 48.

When charges are accumulated in the storage capacitors 34 of the individual pixel portions 40, the TFTs 36 of the individual pixel portions 40 are turned on in order in units of rows by signals supplied from the gate line driver 46 via the gate lines 42. The charges, that are accumulated in the storage capacitors 34 of the pixel portions 40 whose TFTs 36 have been turned on, are transferred through the data lines 44 as charge signals and are inputted to the signal processor 48. Accordingly, the charges, that are accumulated in the storage capacitors 34 of the individual pixel portions 40, are read-out in order in units of rows.

The signal processor 48 is equipped with an amplifier and a sample/hold circuit that are provided for each of the individual data lines 44. The charge signals that are transferred through the individual data lines 44 are amplified at the amplifiers, and thereafter, are held in the sample/hold circuits. Further, multiplexers and A/D converters 48A, that serve as an example of an electric signal converter that converts the charge signals into electric signals that carry image information, are connected in that order to the output sides of the sample/hold circuits. The charge signals, that are held in the individual sample/hold circuits, are inputted in order (serially) to the multiplexers, and analog electric signals are converted into digital electric signals by the A/D converters 48A. An image memory 50 is connected to the signal processor 48. The image information, that are outputted from the A/D converters 48A of the signal processor 48, are stored in order in the image memory 50. The image memory 50 has a storage capacity that can store image information of plural frames. Each time photographing of a radiation image is carried out, the image information obtained by photographing is successively stored in the image memory 50.

The electronic cassette 12 has a wireless communication section 52 and a controller 58. The wireless communication section 52 transmits and receives image data of radiation images wirelessly to and from a display device. The controller 58 is an example of a controller that controls the radiation detecting panel 26, and controls all of the operations of the device.

The wireless communication section 52 acquires, from the image memory 50, the image data that is stored in the image memory 50, and transmission and reception of this image data are carried out via an antenna 53.

Note that the display device has a PC (personal computer) that includes a keyboard and mouse serving as inputs, a display, a CPU, a ROM, a RAM, and the like. The display device also has a communication section for carrying out transmission and reception of data to and from the electronic cassette 12.

The controller 58 has a microcomputer that includes a CPU that governs control of the electronic cassette 12 overall, a ROM serving as a storage medium that stores various types of processing programs, a RAM serving as a work area that temporarily stores data, and a memory serving as a storage in which various types of information is stored, and the like.

Note that the controller 58 is not limited to controlling the operations of the entire device, and may control the operations of some of the structural parts of the device.

The electronic cassette 12 has a power source 54. The power source 54 supplies electric power to at least some of the structural parts including the radiation detecting panel 26, and supplies electric power to structural parts such as various types of circuits and elements in order to operate the electronic cassette 12.

The power source 54 has a battery (a chargeable secondary battery), that serves as a power storage that stores electric power to be supplied by the power source 54, so that the portability of the electronic cassette 12 is not adversely affected.

The power storage that stores the electric power to be supplied by the power source 54 is not limited to a chargeable secondary battery. A nickel-hydrogen battery, a lithium ion battery, a lead storage battery, a capacitor, or the like may be used.

Further, the power source is not limited to a structure that supplies electric power to the structural parts of the entire device as in the present exemplary embodiment, and may supply electric power to some of the structural parts of the device. Further, the electronic cassette 12 may be structured so as to have plural power sources.

As shown in FIG. 3, the housing 20 of the electronic cassette 12 is a shape that, in plan view, i.e., as seen from the side onto which radiation is irradiated (the side at which the subject 16 is positioned), has four sides (four straight lines) 21A, 21B, 21C, 21D at the outer edges thereof, and specifically, forms a quadrilateral shape (quadrangular shape). More specifically, the housing 20 of the electronic cassette 12 is rectangular. Note that the electronic cassette 12 may be a shape at which the corners are rounded.

A side surface 20A that surfaces the side 21A, a side surface 20B that structures the side 21B, a side surface 20C that structures the side 21C, and a side surface 20D that structures the side 21D are formed at the housing 20.

Further, the TFT active matrix substrate 32 (detecting region) as well is formed similarly to the shape of the electronic cassette 12, and is a shape that, in plan view, i.e., as seen from the side onto which radiation is irradiated (the side at which the subject 16 is positioned), has four sides (four straight lines) at the outer edges thereof, and specifically, forms a quadrilateral shape (quadrangular shape). More specifically, the TFT active matrix substrate 32 (the detecting region) is rectangular.

(Grasping Portion provided at Housing 20 of Electronic Cassette 12, and Antenna Disposed at Grasping Portion)

The grasping portion that is provided at the housing 20 of the electronic cassette 12, and the antenna that is disposed at the grasping portion, will be described next.

As shown in FIG. 3, a handle 11 for carrying the electronic cassette 12 is provided at the housing 20 of the electronic cassette 12, as an example of a grasping portion that the person handling the electronic cassette 12 can grasp.

The handle 11 is U-shaped, and the one end portion and the other end portion thereof are connected to the housing 20. Further, the handle 11 is formed integrally with the housing 20, and cannot be removed from the housing 20. A space 11A, through which fingers pass at the time of grasping the handle 11, is formed between the handle 11 and the housing 20.

Note that the grasping portion may be T-shaped, substantially U-shaped, a shape with a hole that is circular or the like formed therein, or the like. It suffices for the grasping portion to be a shape such that it functions as a portion that can be grasped. Further, the grasping portion may be structured by a hole that is formed so as to pass-through the housing 20.

The grasping portion may be a structure that does not pass-through, i.e., may be structured so as to not have a space in which a hand (a portion of a hand such as fingers or the like) is inserted. For example, the grasping portion may be a grasping portion at which is formed a concave portion that a hand (a portion of a hand such as fingers or the like) catches on, or a grasping portion at which is formed a convex portion that can be grasped, or the like.

An antenna 53, that emits electromagnetic wave energy into the air and receives electromagnetic wave energy from the air, is provided at the handle 11. The antenna 53 is connected to the wireless communication section 52, and is used in the transmission and reception of the image data that is stored in the wireless communication section 52.

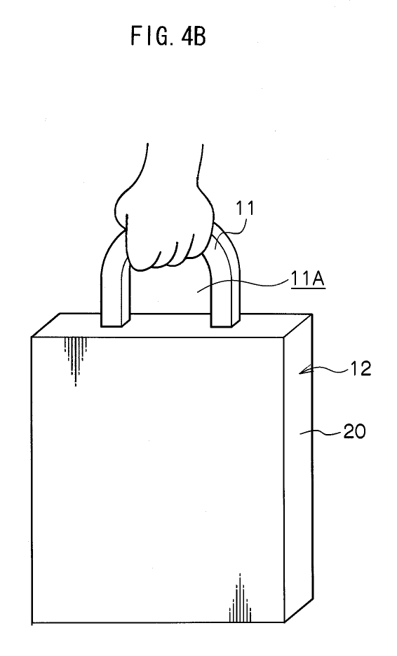

Further, as shown in FIG. 4, the handle 11 is provided such that the one end portion and the other end portion thereof can be pulled-out from the housing 20. Respective portions of the one end portion and the other end portion are housed in the housing 20.

The handle 11 is pulled-out from the housing 20, and the one end portion and other end portion that were housed therein are pulled-out to the exterior of the housing 20. Due thereto, the portion that originally projected-out at the exterior of the housing (the portion grasped by a hand, or the like) moves away from the housing 20. Further, the space 11A through which fingers pass is enlarged.

The antenna 53 is disposed at the portion that originally projects-out at the exterior of the housing 20. Due to the handle 11 being pulled-out, the antenna 53 moves away from the housing 20.

Note that the handle 11 may be structured so as to not be pulled-out from the housing 20, such that the distance between the handle 11 and the housing 20 does not change.

(Operation of Electronic Cassette 12 Relating to Present Exemplary Embodiment)

The operation of the electronic cassette 12 relating to the present exemplary embodiment will be described next.

At the electronic cassette 12 relating to the present exemplary embodiment, wireless transmission and reception of the image data of a photographed radiation image are carried out with the display device 15 by the wireless communication section 52.

It is thought that the electromagnetic wave energy, that is emitted by the antenna 53 that is used in the wireless communication, affects electronic parts as noise.

However, in the present exemplary embodiment, the antenna 53 is provided at the handle 11 that is disposed at the outer side of the housing 20, and a distance between the antenna 53 and electronic parts, such as the radiation detecting panel 26 and the like that are housed in the housing 20, is ensured. The effects of the electromagnetic waves of the antenna can thereby be reduced.

Further, because the antenna 53 is provided at the handle 11, there is no need to separately provide members exclusively for the placement of the antenna 53, and the number of parts of the device does not increase, and the device can be made compact.

Moreover, the handle 11 can be pulled-out from the housing 20, and the antenna 53 and the housing 20 can be moved apart. Therefore, the distance between the antenna 53 and electronic parts, such as the radiation detecting panel 26 and the like that are housed in the housing 20, is lengthened, and the effects of the electromagnetic waves of the antenna 53 can be further reduced.

(Self-Standing Leg 13 as a Structural Member at Which Antenna 53 is Provided)

The structural member at which the antenna 53 is provided is not limited to the handle 11, and may be a self-standing leg 13 that is provided at the housing 20. Hereinafter, the self-standing leg 13 that is provided at the housing 20 will be described.

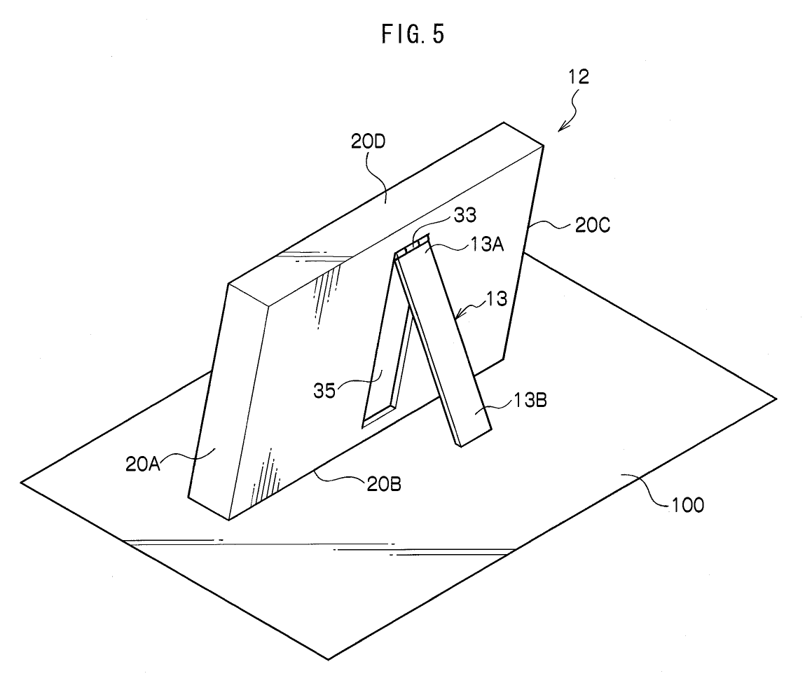

As shown in FIG. 5, the self-standing leg 13 is provided at the housing 20 of the electronic cassette 12.

One end portion of the self-standing leg 13 is rotatably connected to the housing 20 by a hinge 33, and is a connected end portion 13A. The connected end portion 13A is connected to the back surface of the housing 20 that is the side opposite an irradiation surface 22 at which the radiation X is irradiated (the detection surface of the radiation detecting panel 26).

The other end portion is a free end portion 13B that approaches and moves away from the housing 20 due to the connected end portion 13A being rotated by a specific angle. As shown in FIG. 5, the free end portion 13B is separated by a specific interval from the housing 20, and is used as a leg that supports the housing 20. The connected end portion 13A is disposed at a side surface 20D side of the housing 20. The free end portion 13B is disposed at a side surface 20B side of the housing 20.

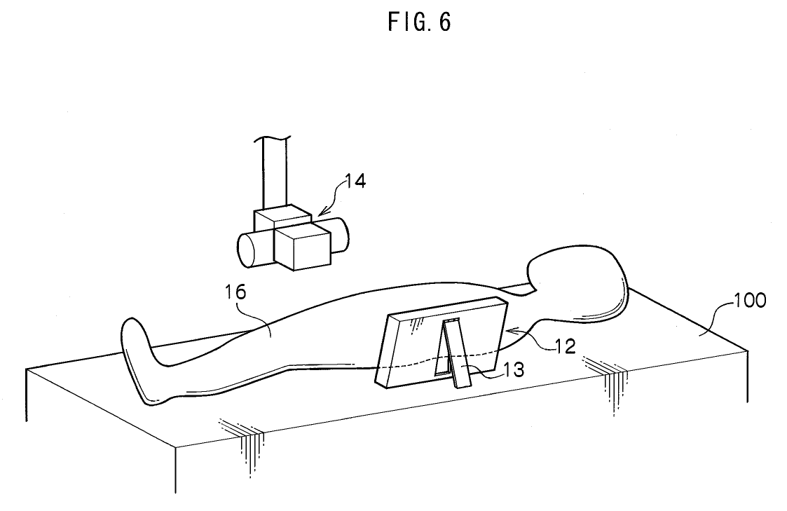

By making the housing 20 stand on its own with the side surface 20B of the housing 20 and the free end portion 13B of the self-standing leg 13 downward, the detecting surface of the radiation detecting panel 26 is directed toward the side. As shown in FIG. 6, the electronic cassette 12 is placed on a photographing stand 100 at the side of the subject 16 who is lying down on the photographing stand 100, and the radiation generating section 14 is disposed so as to oppose the electronic cassette 12 with the subject 16 therebetween. Photographing from the side is thereby possible.

Further, a recess 35 for accommodating the self-standing leg 13 is formed in the housing 20. When not in use, the self-standing leg 13 can be accommodated in the recess 35.

The antenna 53, that emits electromagnetic wave energy into the air and receives electromagnetic wave energy from the air, is provided at the self-standing leg 13. The antenna 53 is connected to the wireless communication section 52, and is used in the transmission and reception of the image data that is stored in the wireless communication section 52.

It is desirable to place the antenna 53 at a position that is far from the housing 20, and preferable to place the antenna 53 at the free end portion 13B side of the self-standing leg 13.

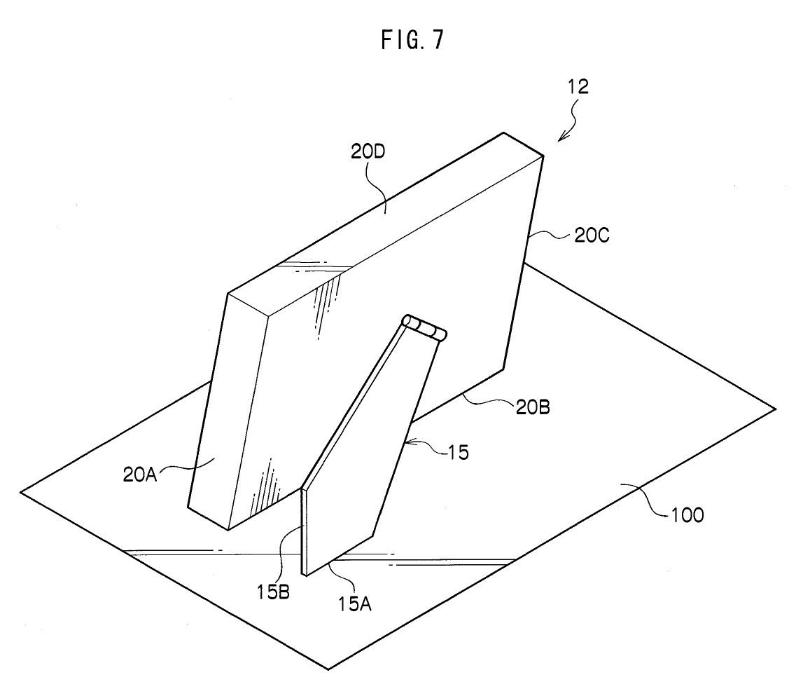

Instead of the self-standing leg 13, as shown in FIG. 7, a self-standing leg 15 may be provided that can make the housing 20 stand on its own both horizontally with its length being horizontal with respect to the photographing stand 100 (the orientation shown in FIG. 7) and vertically with its length being vertical with respect to the photographing stand 100.

As shown in FIG. 6, when the housing 20 is made to stand on its own horizontally with the side surface 20B, that structures the side 21B that is a long side of the housing 20, downward, the housing 20 is supported by one surface 15A of the free end portion of the self-standing leg 15.

When the housing 20 is made to stand on its own with a side surface 20A, that structures the side 21A that is a short side of the housing 20, downward, the housing 20 is supported by another surface 15B of the free end portion of the self-standing leg 15.

Due thereto, the orientation of the electronic cassette 12 can be changed in accordance with whether the region to be photographed is long vertically or is long horizontally.

(Functions at Self-Standing Leg 13)

The functions at the self-standing leg 13 will be described next.

At the electronic cassette 12 relating to the present exemplary embodiment, wireless transmission and reception of the image data of a photographed radiation image are carried out with the display device 15 by the wireless communication section 52.

It is thought that the electromagnetic wave energy, that is emitted by the antenna 53 that is used in the wireless communication, affects electronic parts as noise.

However, in the present exemplary embodiment, the antenna 53 is provided at the self-standing leg 13 that is disposed at the outer side of the housing 20. Therefore, the antenna 53 and the structural portion that has the electronic parts, such as the radiation detecting panel 26 and the like that are housed in the housing 20, have a sufficient distance therebetween. Consequently, the effects of the electromagnetic waves of the antenna can be reduced.

Further, because the antenna 53 is provided at the self-standing leg 13, there is no need to separately provide members exclusively for the placement of the antenna. Accordingly, the number of parts of the device does not increase, and the device can be made compact.

Moreover, the free end portion of the self-standing leg 13 can be swung-open from the housing 20, and the antenna 53 and the housing 20 can be moved apart. Accordingly, the distance between the antenna 53 and electronic parts, such as the radiation detecting panel 26 and the like that are housed in the housing 20, is lengthened, and the effects of the electromagnetic waves of the antenna 53 can be further reduced.

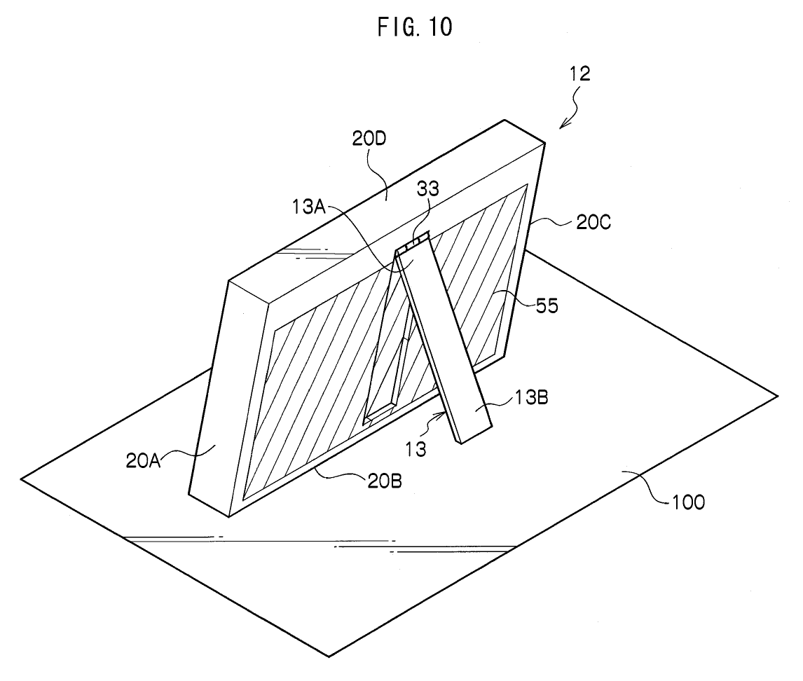

Note that, as shown in FIG. 10, a radio wave absorber 55 that absorbs radio waves may be provided at the back surface side of the housing 20 (including the recess 35). In this structure, the radio wave absorber 55 is disposed between the housing 20 and the free end portion 13B at which the antenna 53 is provided. Accordingly, even after the free end portion 13B of the self-standing leg 13 is moved, the radio wave absorber 55 is positioned between the antenna 53 and the housing 20. Therefore, due to the radio wave absorber 55 absorbing radio waves, effects of electromagnetic waves on the electronic parts, such as the radiation detecting panel 26 and the like that are accommodated within the housing 20, can be reduced.

(Modified Example of Self-Standing Leg 13)

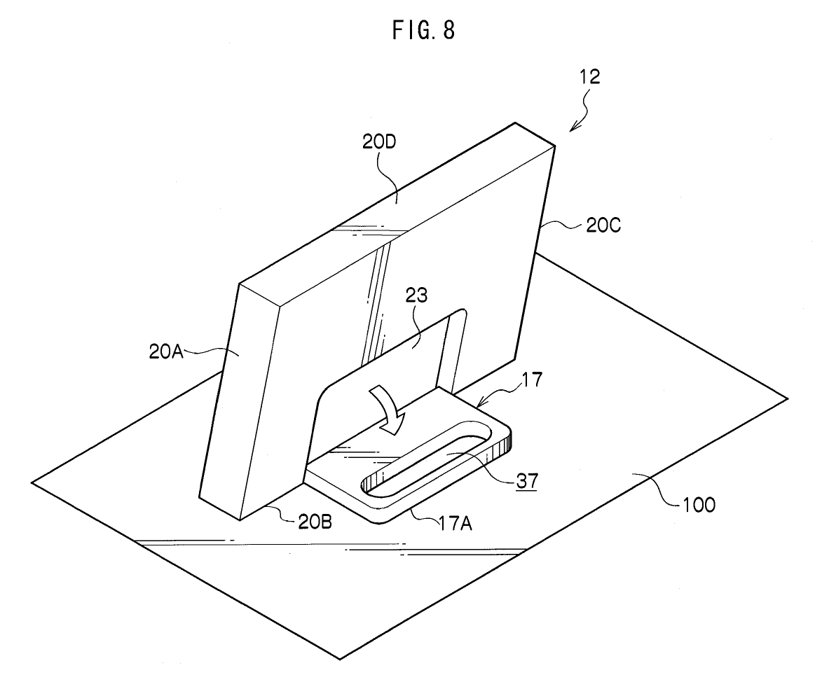

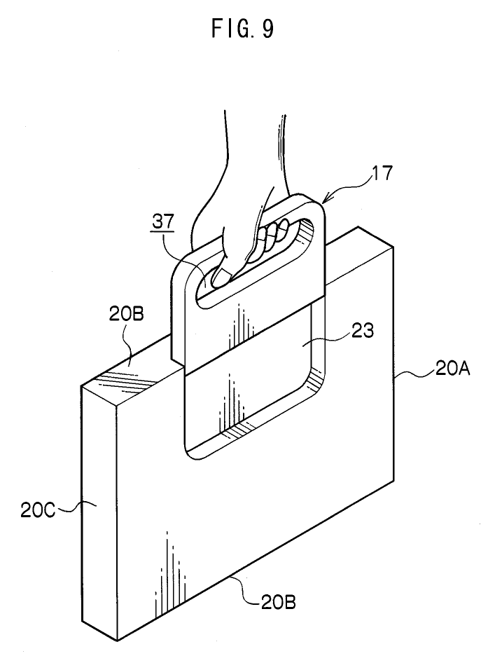

As shown in FIG. 8 and FIG. 9, a self-standing leg 17, that is also used as a grasping portion that the person handling the electronic cassette 12 can grasp, may be provided instead of the above-described self-standing leg 13.

An opening portion 37, through which the fingers of the person handling the electronic cassette 12 can pass, is formed in the self-standing leg 17. A person can grasp the self-standing leg 17 by passing his/her fingers through the opening portion 37.

One end portion of the self-standing leg 17 is rotatably connected, and is a connected end portion. The connected end portion is connected to the outer edge portion of the housing 20. A recess 23 for accommodating the self-standing leg 17 is formed in the central portion of the housing 20.

The self-standing leg 17 is accommodated in the recess 23 by rotating the free end portion that is the other end portion toward the recess 23 with the connected end portion being the center of the rotation.

The self-standing leg 17 can be used as a grasping portion by rotating the self-standing leg 17, that is accommodated in the recess 23, by 180° for example and moving it toward the side opposite the recess 23. As shown in FIG. 9, a person passes his/her fingers through the opening portion 37 of the self-standing leg 17 and grasps the self-standing leg 17, and can carry the electronic cassette 12.

The electronic cassette 12 can be made to stand on its own by rotating the self-standing leg 17, that is accommodated in the recess 23, by 90° for example such that a side surface 17A of the self-standing leg 17 is positioned on the same plane as the side surface 20B of the housing 20, and, as shown in FIG. 8, placing the side surface 20B of the housing 20 and the side surface 17A of the self-standing leg 17 downward.

In accordance with the above-described aspect of the present invention, the antenna is provided at the structural member that is disposed at the outer side of the housing. Therefore, the distance between the antenna and electronic parts and the like, that structure the radiation detecting section accommodated within the housing, can be ensured, and thus, the effects of the electromagnetic waves of the antenna on the electronic parts can be reduced.

Further, because the antenna is provided at a structural member that is integral with the housing, there is no need for additional parts, and the device structure is compact.

Accordingly, in accordance with the above-described structure, the effects of the electromagnetic waves of the antenna on the electronic parts can be reduced, without the device being made larger.

The structural member of the portable radiation detector relating to the aspect of the present invention is pulled-out from the housing, and the antenna and the housing are moved apart.

In accordance with this structure, because the structural member is pulled-out from the housing and the antenna and the housing are moved apart, the distance between the antenna and the electronic parts and the like, that structure the radiation detecting section accommodated within the housing, is lengthened, and the effects of the electromagnetic waves of the antenna on the electronic parts can be further reduced.

One end portion of the structural member of the portable radiation detector relating to the aspect of the present invention is provided rotatably at the housing, and another end portion of the structural member is swung-open and separated from the housing, with the one end portion being a center of rotation, and the antenna and the housing are moved apart.

In accordance with this structure, the other end portion of the structural member is swung-open and separated from the housing, with the one end portion being the center of the rotation, such that the antenna and the housing are moved apart. Therefore, the distance between the antenna and the electronic parts and the like, that structure the radiation detecting section accommodated within the housing, is lengthened, and the effects of the electromagnetic waves of the antenna on the electronic parts can be further reduced.

The structural member of the portable radiation detector relating to the aspect of the present invention is a grasping portion for grasping at a time of carrying the portable radiation detector.

In the above-described structure, the structural member is a grasping portion for grasping at the time when the portable radiation detector is carried, and members exclusively for the placement of the antenna are not provided separately. Therefore, the number of parts of the device does not increase, and the device can be made compact.

The structural member of the portable radiation detector relating to the aspect of the present invention is a self-standing leg that makes the housing stand on its own.

In the above-described structure, the structural member is a self-standing leg that makes the housing stand on its own, and members exclusively for the placement of the antenna are not provided separately. Therefore, the number of parts of the device does not increase, and the device can be made compact.

In the portable radiation detector relating to the aspect of the present invention, a radio wave absorber is disposed at a back surface of the housing which back surface is at a side opposite a side at which radiation is irradiated.

Due to the radio wave absorber absorbing radio waves, the effects of the electromagnetic waves of the antenna on the electronic parts can be reduced effectively.

Because the present invention is structured as described above, effects of electromagnetic waves of an antenna on electronic parts can be reduced, without the device being made larger.

The present invention is not limited to the above-described exemplary embodiment, and various changes, modifications and improvements can be made thereto.

What is claimed is:

1. A portable radiation detector comprising:
a housing accommodating therein a radiation detecting section that detects radiation;
a structural member disposed at an outer side of the housing and formed integrally with the housing; and
an antenna, provided at the structural member, for carrying out wireless communication of image data of a radiation image.

2. The portable radiation detector of claim 1, wherein the structural member is pulled out from the housing, and the antenna and the housing are moved apart.

3. The portable radiation detector of claim 1, wherein one end portion of the structural member is provided rotatably at the housing, another end portion of the structural member is swung open and separated from the housing with the one end portion being a center of rotation, and the antenna and the housing are moved apart.

4. The portable radiation detector of claim 1, wherein the structural member is a grasping portion for grasping at a time of carrying the portable radiation detector.

5. The portable radiation detector of claim 2, wherein the structural member is a grasping portion for grasping at a time of carrying the portable radiation detector.

6. The portable radiation detector of claim 3, wherein the structural member is a grasping portion for grasping at a time of carrying the portable radiation detector.

7. The portable radiation detector of claim 1, wherein the structural member is a self-standing leg that allows the housing to stand on its own.

8. The portable radiation detector of claim 2, wherein the structural member is a self-standing leg that allows the housing to stand on its own.

9. The portable radiation detector of claim 3, wherein the structural member is a self-standing leg that allows the housing to stand on its own.

10. The portable radiation detector of claim 1, wherein the structural member is a self-standing leg that allows the housing to stand vertically or horizontally.

11. The portable radiation detector of claim 1 further comprising a radio wave absorber that is disposed at a back surface of the housing, which back surface is at a side opposite to a side at which radiation is irradiated.
